(19) United States
(12) Patent Application Publication
(10) Pub. No.: US 2004/0030801 A1
(43) Pub. Date: Feb. 12, 2004

(54) Method and system for a client to invoke a named service

(76) Inventors: Timothy L. Moran, Argyle, TX (US); Kaiser Chen, San Diego, CA (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/353,052

(22) Filed: Jan. 29, 2003

Related U.S. Application Data
(60) Provisional application No. 60/388,378, filed on Jun. 14, 2002.

(51) Int. Cl. G06F 15/173

(52) U.S. Cl. 709/244

(57) ABSTRACT

The invention is a network and method for a client to request a named service in a network. The method includes transmitting a service request from the client in the network using a protocol in a layer in a protocol stack between a logical name of the named service and a physical address of a server, within a pool of servers in the network, which will provide the named service, to a service contact point of the network for the pool of servers; the service contact point, in response to the service request, selects the server which will provide the named service from the pool of servers; the service contact point forwards the request for the selected server to the selected server; and the selected server responds to the client with a message using the protocol indicating the selection of the selected server to the client.

### CROSS REFERENCE TO RELATED APPLICATION

This application claims the benefit of the filing date of U.S. Serial No. 60/388,378, filed Jun. 14, 2002, entitled “Optimized RSERPOOL Query” and is incorporated by reference in its entirety.

### BACKGROUND OF THE INVENTION

1. Field of the Invention

The present invention relates to selection of a named service by pool element users (PU) and includes modifying signalling behavior of the Reliable Server Pooling working group (RSERPOOL) architecture.

2. Description of the Prior Art

The architecture of RSERPOOL in a network 10 is illustrated in FIG. 1. RSERPOOL is in the process of defining a set of protocols which, when deployed, will enable providing cost effective reliable services from a pool of servers known as pool elements (PE). The architecture of FIG. 1 permits a client PU to reliably invoke a specific named service. The RSERPOOL architecture of FIG. 1 attempts to achieve reliability by providing a pool of servers PE₁ . . . PEₙ from which the PU selects one server PE using the Aggregate Server Access Protocol (ASAP). The ASAP protocol layer provides a level of abstraction between a logical name of a service known as a pool handle—e.g. file transfer protocol (FTP) and the actual physical address of a server PE in the pool.

To select a PE, the PU uses the ASAP layer to send a name resolution query communication 1 (FTP login request) to a name resolution server known as an Endpoint Name Resolution Protocol (ENRP) server. The ENRP server queries the servers of the appropriate service type. The ENRP server returns a list of presumed PEs available to the ASAP layer which is communication 2. The response may also include policy information to be used by the PU in the ASAP layer for selecting the most appropriate PE (e.g. least used). Once the PU has received the list of PEs, the PU uses the ASAP layer to select one PE, e.g. PE₂ and attempts to invoke the service by sending the PE a FTP login request 3 which is communication 3. The selected PE₂ follows with a FTP login response which is communication 4 providing information about the connection for the requested service from PE₂ to the PU. Then other FTP control data is sent to the PU which is communication 5. If for some reason the PE does not provide the requested service (e.g. fails to respond to communication 4), the PU uses the ASAP layer to select another PE from the list until an available PE is found and the transfer is complete.

Once communication is established between the PU and the PE₂ by communication 4, failover may be realized. Failover is when a primary server failure occurs and another server, such as a hot standby, is invoked to continue the service. It is the situation of reselecting (moving over to) another server when the one in use fails. To do this, the standby receiver server has to know precisely what the original server is doing, i.e. the current state of the service session/call/transaction. This requires state information sharing among the list of PEs returned by the ENRP server and cached in the PE. It also requires the PE to retry the communication. It should be noted that the state sharing method is not described in RSERPOOL. There is also no mechanism defined in RSERPOOL using the ASAP layer to enforce the adherence to the PE selection policy. While the network recommends an order of selection, the selection is not mandatory on the PU.

There are at least three problems with the reliability solution of the currently envisioned RSERPOOL architecture illustrated in FIG. 1.

1. The PU is in control of which PE is selected. This restricts the network 10 to best manage the network resources (load share) since it can only do so to the granularity of the number of PEs provided in the list—if at all. While the list of PEs may be prioritized, there is no guarantee that the PU will pick the proper PE. In fact, the PU may not pick any PE on the list since the PU may utilize a PE learned of by other means. The network must store policy state information in the list of PUs provided by the ENRP server so that the PUs may in turn enforce policy when receiving requests from PEs.

2. The protocol structure clearly distinguishes between an ENRP server and PEs since the address resolution query is sent to an ENRP server while the service request is sent to a selected PE which makes the ENRP server a single point of failure and the candidate of attacks, such as denial of service. It is desirable to hide the network configuration as much as possible.

3. At least a four message exchange sequence is required involving the PU and ENRP server as described above.

To reduce session setup delay, the PUs may cache a prior query and use a cached server for subsequent communications not requiring the previously described procedure of the ENRP server.

In the prior art, the PUs can receive a list of servers in response to the ASAP query to the ENRP server. Later on, when the PU needs a server, it may simply use its old list. Perhaps the old list is valid and perhaps it is not. Valid means that the server selected from the cached pool is in service and is the least recently used, for example. It is best that the PU invoke an ENRP query before each service request to provide the most accurate available information. However, there is nothing preventing the PU from using old data. This does not bode well for the user (PU) as well as the network in that a poorer quality of service is achieved than could be. In a malicious case, a PU(s) can continually select a single PE and attack it.

FIG. 2 illustrates a signalling diagram of session set up between a PU and a PE through the ENRP of FIG. 1. As illustrated, the synchronization between the PU and ENRP is assumed and is identified by step 0a which is the transmission of synchronization information from the PU to the ENRP and step 0b which is the transmission of synchronization information from the ENRP to the PU. The setup of a session between the PU and the PE is achieved by communications 11, 12, 15 and 16 which are at the application level: an acknowledgment plus a ENRP request 11 from the PU to the ENRP, an acknowledgment plus ENRP response 12 from the ENRP to the PU, an acknowledgement plus service request 15 signal from the PU to the PE and an acknowledgement plus service response 16 from the PE to the PU and three TCP level communications which are synchronization transmissions 13 and 14 and an acknowledgment 17. The above-described signalling to establish a session has substantial application layer overhead which may be very disadvantageous

Savings of one message at the transport layer saves on RF bandwidth and mobile resources (battery due to interrupt processing). Now saving one message (at transport) may not seem significant, but a SYN/ACK at the TCP layer is a much smaller message than at the application layer. Also, application layer messages require more processing since the application software (process) must be invoked which consumes battery. It is possible, due to the size of a message, a different size of RF channel must be allocated and setup. That is, small messages can be sent over common shared channels. Larger messages require a setup message over the shared channel to establish a non-shared (dedicated) channel to send the larger message on and then the dedicated channel has to be released which is additional overhead.

### SUMMARY OF THE INVENTION

The present invention provides a method and system for a client to obtain a named service from a server within a pool of servers and in a preferred application modifies the signalling behavior of the RSERPOOL architecture of FIG. 1.

1. In lieu of storing an application service request in the PU and sending an explicit name resolution query, the PU sends an application service request to a service contact point which may be a default service contact point when no other service contact is available since the first ASAP message needs to be sent to a known location. The service contact point may be an ENRP server or an ENRP server plus a PE. In a preferred application, the service request is stored in the ASAP layer which may be in the RSERPOOL architecture of FIG. 1 and the application service request to the service point contact that may be an ENRP server which is transmitted as part of a message using the ASAP layer.

2. The contact point selects a PE and forwards the request to the selected PE indicating that the PE has been identifying in the network to provide the named service to the PU. The contact point itself may be the PE which is selected.

3. The selected PE initiates the service and responds directly to the PU with a message which must include the application response but may also include backup server addresses.

A method for a client to request a named service in a network in accordance with the invention includes transmitting a service request from the client in the network using a protocol in a layer in a protocol stack between a logical name of the named service and a physical address of a server, within a pool of servers in the network, which will provide the named service, to a service contact point of the network for the pool of servers; the service contact point, in response to the service request, selects the server which will provide the selected service from the pool of servers; the service contact point forwards the request for the selected service to the selected server; and the selected server responds to the client with a message using the protocol indicating the selection of the selected server to the client. The protocol may be an Aggregate Server Access Protocol (ASAP). The service contact point may be a server which is an endpoint name resolution protocol server. The name of the service may be a pool handle. The response of the server to the client may be transmitted directly from the selected server to the client and control messages may be transmitted from the selected server to the client after transmission of the response wherein the response is correlated with the request using request ID information which may be either unprotected or encrypted.

A network in accordance with the invention includes a client, a pool of servers and at least one service contact point of the network for the pool of servers and wherein: the client requests a named service in the network by transmitting a service request from the client in the network using a protocol in a layer in a protocol stack between a logical name of the named service and a physical address of a server, within the pool of servers in the network, which will provide the named service, to a service contact point of the network for the pool of servers, the service contact point, in response to the service request, selects the server which will provide the named service from the pool of servers, the service contact point forwards the request for the selected server to the selected server, and the selected server responds to the client with a message using the protocol indicating the selection of the selected server to the client. The protocol may be an Aggregate Server Access Protocol (ASAP). The service contact point may be a server which is an endpoint name resolution protocol server. The name of the service may be a pool handle. The response of the server to the client may be transmitted directly from the selected server to the client and control messages may be transmitted from the selected server to the client after transmission of the response.

### BRIEF DESCRIPTION OF THE DRAWINGS

FIG. 1 illustrates the operation of a prior art network for a client to request a named service in a network.

FIG. 2 illustrates a sequence of communications of the prior art network of FIG. 1 on the application and transport levels for the client to obtain the named service.

FIGS. 3a-c illustrate embodiments of the invention for requesting a named service in a network.

FIG. 4 illustrates a sequence of communications in FIGS. 3a-c used by the invention on the application and transport levels for the client to obtain the named service.

Like parts are identified identically throughout the drawings.

### DESCRIPTION OF THE PREFERRED EMBODIMENT OF THE INVENTION

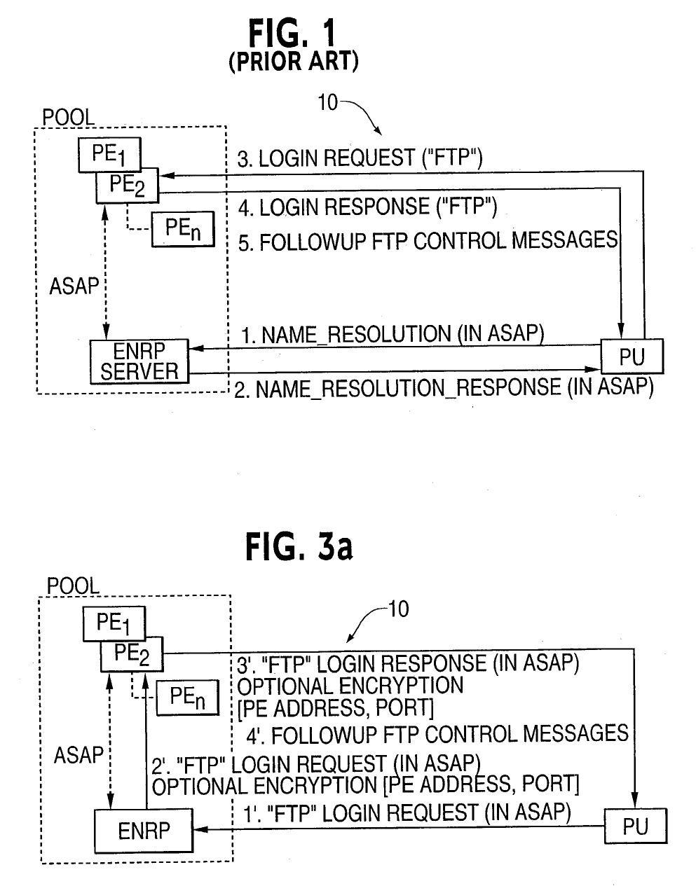

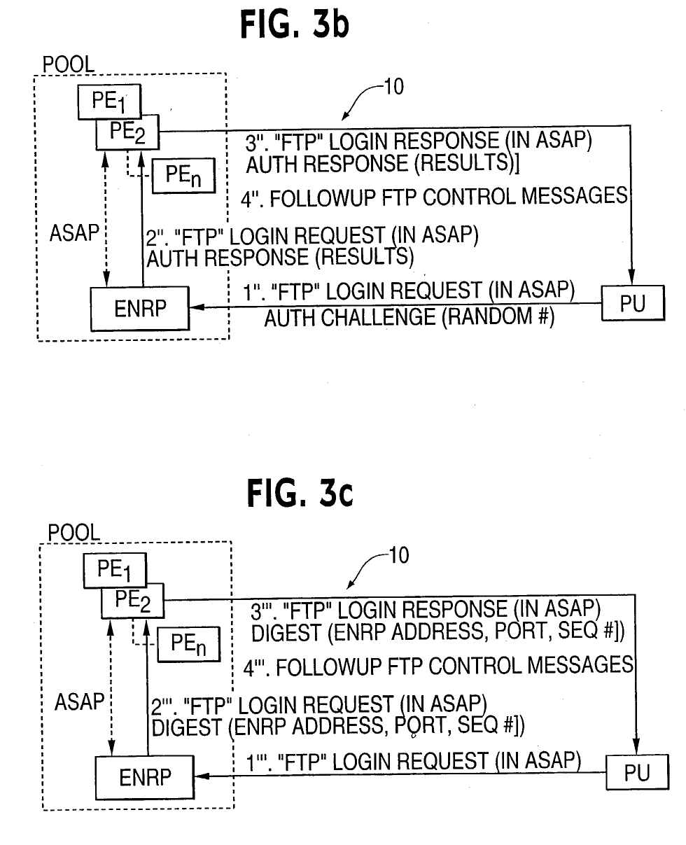

FIG. 3a illustrates a diagram of a first embodiment of the invention. The invention in a preferred embodiment modifies the signalling flow of the prior art architecture in network 10 of FIG. 1 in the following manner. The PU obtains an IP address for a service from a directory name service (DNS) (e.g. an alias name) or other means. When the ASAP layer in the PU receives a send message request from the application layer above the ASAP layer (e.g. an FTP login request), rather than store this message for later transmission, the PU's ASAP layer encapsulates the application request into an ASAP FTP login request 1′ which, for example, is (name resolution or a new type of message such as “Pooled Service Invocation Request”) forwarded to a service contact point of the network 10 which may be an ENRP server or an ENRP server plus a PE. The pool handle identifying the pool is “FTP”. Optionally, the request may include an authentication challenge as illustrated in the embodiment of FIG. 3b. The ENRP server of FIG. 3a has capabilities of the prior art ENRP server, but is not limited thereto and may perform other functions in the network 10. The ENRP server determines the type of application being requested. An existing ASAP defined FTP parameter may be used or deleted and obtained from the application message itself. The ENRP server selects one of the PE servers PE₁-PE_{N} to provide the named service to the PU. The selection process by the ENRP server considers the availability of the service from the pool and the load for the selected service from the pool.

The forwarded request 1′ includes transaction identifying information allowing the PU to associate the response from the selected PE with the PU's original request to the ENRP server and/or to verify that the response is legitimate. This could include such information as encryption of the ENRP's IP address and port and even sequence # used for the initial request (or other PE identifying information) of the PE selected by the ENRP server.

In a loose and well trusted environment including transaction identifying information is optional since the application layer may have sufficient information to associate the request with the response. Take, for example, the SIP protocol, which has command sequence numbers (CSEQ) and dialogue IDs which allow correlation at the application layer. This information can be obtained through a common means to correlate and improve confidence that this response is for the request sent to the Service Contact Point (and not rogue). Using message digest and encryption are optional and provide better assurance, but are not required in a secure trusted network. Transport layer security is always an option and not defined herein. (TLS is a known standard for transport layer security.) However, the operator may choose the techniques described herein in lieu of TLS.

The ASAP level message 2′ is forwarded to the selected PE which, as illustrated, is PE₂ which includes the aforementioned optional encrypted information. PE₂ formulates an initial application layer response and embeds it into the ASAP response. The PE₂ sends a FTP login response 3′ directly to the PU which includes the aforementioned encrypted information. Control messages 4′ using ASAP are subsequently transmitted. Whether or not authentication was requested by the PU, identification information may be sent to the PU in the ASAP layer. The identification includes the information created by the ENRP server.

The ASAP layer of the PU receives the response. The ASAP layer of the PU notes that the response came from a different address than the FTP login request 1′ but that the original request address is included as part of the “Request Identification Information” contained therein. The Request Identification Information parameter may include diverse types of information which may be encrypted such as the request's IP address, port #, and security information (i.e. the original destination address information). If a reliable transport protocol, e.g. TCP, is required by the application, the ASAP layer invokes its establishment (e.g. transmission control protocol TCP SYNC message). Once completed, the ASAP application layer response is passed up to the application layer (e.g. FTP). Further application messages are received by the ASAP layer which, for the most part, forwards the application messages to the required transport protocol with the required parameters (e.g. destination address).

TCP is a transport layer protocol. FTP is on top of TCP. ASAP is below TCP and the FTP layers as a shim. The transport layer establishment herein is more likely to occur since this is a new PE selected for use by the PU. However, if the PE selected is also the Service Contact Point (aka ENRP server), then a TCP connection may not be needed because a PU may keep the connection to a ENRP server up for extended periods of time along with the address of the server and transport information.

It may be possible to bypass ASAP for subsequent messages when the application specifies that the ASAP layer is not to be used to retry failed messages. This defeats the purpose of reliability but not availability of services when server addresses are cached.

The present invention has the following characteristics when compared to the prior art.

1. The invention provides substantial enforcement of network policy (as well as validating PE availability) since the PE selection is done in the network and indicated to the PU by the PE already selected. Complex policy management between the network contact point ENRP server and the PEs is not needed since the network selects the PE. The invention does not require the PU to store the service request until a server has been selected. Instead the service level request is included in the ASAP request to the service contact point which could be a name resolution request.

However, while the PEs are required to support ASAP, there is no requirement to encapsulate a service response (e.g. FTP login response) in an ASAP message. When the invention is practiced with a preferred application using the RSERPOOL protocol, a change to the standards regarding the current RSERPOOL protocol may be needed.

Cached server addresses are provided by the invention like in the prior art of FIG. 1. Doing so permits the PU to select the server providing a named service in future requests. Rules regarding the ASAP protocol may specify that alternative PE addresses are only to be used for fault recovery and not for server selection of subsequent service request.

This can be enforced in the following manner. The network 10 is set up so that only the network creates TCP connections to PUs in accordance with the invention and thus responds to queries from a Service Contact Point of known address. The only time the PU can set up a service (i.e., a PE will accept a request from an outside (PU) address, is when the PE includes in the request the former server providing service). The failover PE can check interval state sharing information that, in fact, PUₓ was formally using PU_{y} and that PU_{y} and PE_{z} as a backup server for PE_{y} and thus accept their service request. Hence, PU initiated connections are an exception and can trigger exception handling code—an instant firewall.

2. The state machine in the PU is simpler than in the prior art. The PU does not have to store application requests until the service contact point of the network 10 provides a PE address to be sent to the PE. The PUs knowledge of the network architecture is minimized. The invention may be implemented such that there is no distinction between the ENRP server and PEs from the perspective of the PU. PUs may have default addresses for the service (e.g. via DNS resolution) which may be construed as the ENRP server. However, since ENRP servers and PEs can reside at the same address and the network 10 can assign different service contact point (ENRP capable) servers, the network architecture can be hidden to some degree.

3. The invention reduces the amount of PU application layer signaling by 50% for a single query/response service establishment phase as described above with reference to FIG. 1. This is because the Application Query-Response 1 of FIG. 1 is combined with the Server selection query-response of FIG. 1 as the ASAP based FTP login requests 1′, 1″ and 1′″ of FIGS. 3a-c. Services with more complex establishment phases (i.e. more than 2 messages) will benefit less.

Some options exist for the PE to PU response:

For an application, such as SIP, parameters may be used to store initial request information for added correlation of the original request (to the Service Contact Point) with the response (from the PE). For example, the SIP sent-by parameter could be used. However, the inclusion of such is optional since application layer protocols, such as SIP, already include sufficient request-response correlation tools regardless of the transport protocols.

FIG. 3b illustrates a modification of the embodiment of FIG. 3a in that the communication 1″ includes the authentication challenge, including a random number and the communication 2″ includes the authentication response results in place of encryption of the PE address and port in FIG. 3a. The communication 3′ also includes the authentication response and results.

The request 1″ includes an Authentication Challenge, the ENRP server generates an Authentication Response and includes it in the request 2″ forwarded to the selected PE. If authentication is not done by the ENRP server, the selected PE must generate the Authentication Response which is sent as a part of communication 3″. Authentication secrets are obtained by the authenticator (ENRP server or PE) either locally of from a trusted source (e.g. AAA server) using known techniques/protocols such as RADIUS or DIAMETER, etc.

Another possibility is the authentication information contains a unique random number. Combinations of the above are also possible. The information may be encrypted by the use of a key so that only the PU can decipher it. To avoid man-in-the middle attacks, the PU may want to authenticate the PE sending the response. Only the trusted network will have the proper layers to generate a passing response.

The embodiment of FIG. 3c includes in communication 2′″ a digest of the ENRP address, port and sequence number. Communication 3′″ also includes this digest information which avoids a message integrity that no man in the middle has sent this message. That is, the request information may be sent in the clear, but not altered by a man in the middle which is sufficient to ensure that this response is valid for the prior response.

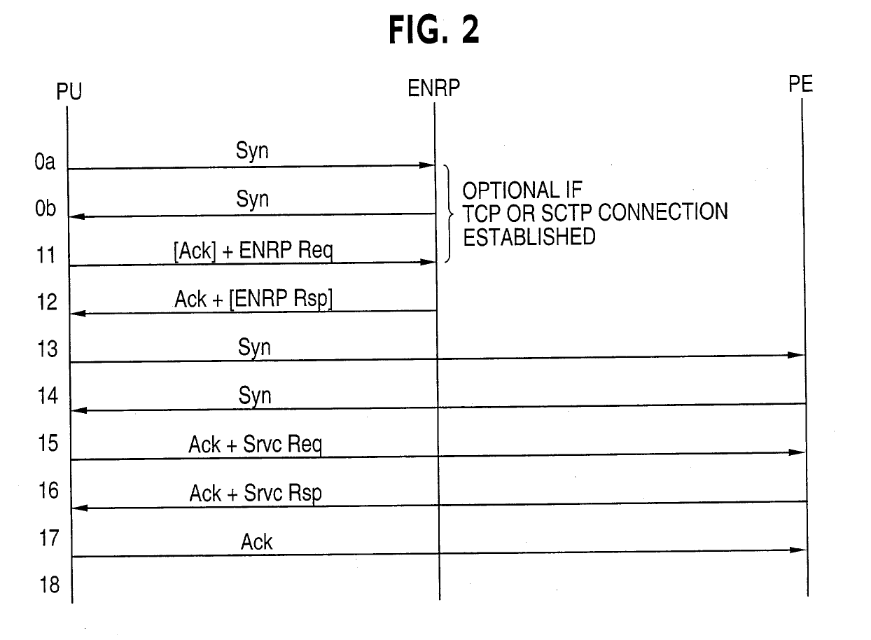

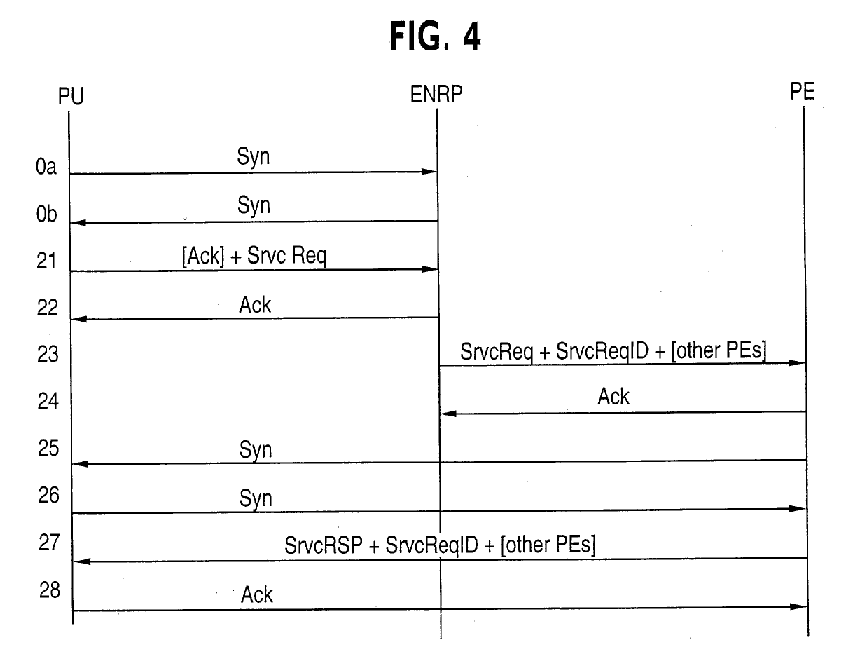

FIG. 4 is a diagram representing the sequence of communications for setting up a session in accordance with the present invention as illustrated in FIGS. 3a-3c. The difference between FIG. 4 and FIG. 2 is that, in FIG. 4 only communications 21 and 22 are at the application level with communications 25-28 being at the transport TCP level.

It is seen that the present invention minimizes the number of application level communications which enhances performance.

While the invention has been described in terms of its preferred embodiment, it should be understood that numerous modifications may be made without departing from the spirit and scope of the invention. It is intended that all such modifications fall within the scope of the appended claims.

1. A method for a client to request a named service in a network comprising:
transmitting a service request from the client in the network using a protocol in a layer in a protocol stack between a logical name of the named service and a physical address of a server, within a pool of servers in the network, which will provide the named service, to a service contact point of the network for the pool of servers;
the service contact point, in response to the service request, selects the server which will provide the named service from the pool of servers;
the service contact point forwards the request for the selected server to the selected server; and
the selected server responds to the client with a message using the protocol indicating the selection of the selected server to the client.

2. A method in accordance with claim 1 wherein:
the protocol is Aggregate Server Access Protocol (ASAP).

3. A method in accordance with claim 1 wherein:
the service contact point is a server.

4. A method in accordance with claim 3 wherein:
the server is an endpoint name resolution protocol server.

5. A method in accordance with claim 1 wherein:
the name of the service is a pool handle.

6. A method in accordance with claim 1 wherein:
the response of the selected server to the client is transmitted directly from the selected server to the client; and
control messages are transmitted from the selected server to the client after transmission of the response of the selected server to the client.

7. A method in accordance with claim 1 wherein:
the response of the selected server to the client is transmitted directly from the selected server to the client; and
control messages are transmitted from the selected server to the client after transmission of the response of the selected server to the client wherein the response is correlated with the request using request ID information which is at least one of unprotected, protected and encrypted integrity.

8. A network comprising:
a client, a pool of servers and a service contact point of the network for the pool of servers and wherein:
the client requests a named service in the network by transmitting a service request from the client in the network using a protocol in a layer in a protocol stack between a logical name of the named service and a physical address of a server, within the pool of servers in the network, which will provide the named service, to a service contact point of the network for the pool of servers, the service contact point, in response to the service request, selects the server which will provide the named service from the pool of servers, the service contact point forwards the request for the selected server to the selected server, and the selected server responds to the client with a message using the protocol indicating the selection of the selected server to the client.

9. A network in accordance with claim 8 wherein:
the protocol is Aggregate Server Access Protocol (ASAP).

10. A network in accordance with claim 8 wherein:
the service contact point is a server.

11. A network in accordance with claim 10 wherein:
the server is an endpoint name resolution protocol server.

12. A network in accordance with claim 8 wherein:
the name of the service is a pool handle.

13. A network in accordance with claim 8 wherein:
the response of the selected server to the client is transmitted directly from the selected server to the client; and
control messages are transmitted from the selected server to the client after transmission of the response of the selected server to the client.
